(19) United States
(12) Patent Application Publication
(10) Pub. No.: US 2015/0035945 A1
(43) Pub. Date: Feb. 5, 2015

(54) METHOD AND SYSTEM FOR MANUFACTURING A WIG HEAD SHELL

(71) Applicant: HIKING GROUP SHANDONG HAICHUAN HAIRS CO. LTD., Qingdao (CN)

(72) Inventor: HANG (SOPHIE) ZHANG, QINGDAO (CN)

(21) Appl. No.: 14/444,201

(22) Filed: Jul. 28, 2014

(30) Foreign Application Priority Data
May 31, 2013 (CN) 201310213889.7

(51) Int. Cl. H04N 13/02; A41G 3/00

(52) U.S. Cl. CPC H04N 13/0275; A41G 3/0075; H04N 13/0203
USPC 348/46

(57) ABSTRACT

An object head is prepared by placing a plurality of markers on the object head at a location where a wig is needed. A digital stereoscopic camera acquires a plurality of images of the object head at the location where the wig is needed from a plurality of different positions. Each of the images contains at least three of the markers on the object head. The digital image files are transferred from the camera to a digital processing device and the images are combined (stitched, sewn) in the digital processing device, where a three-dimensional digital model of the object head is generated. The wig head shell is manufactured from the three-dimensional model, for example by way of a 3D printer or by manual forming of a plaster model.

### CROSS-REFERENCE TO RELATED APPLICATION

This application claims the priority, under 35 U.S.C. §119, of Chinese patent application No. CN 2013 102 13889.7, filed May 31, 2013; the prior application is herewith incorporated by reference in their entirety.

### BACKGROUND OF THE INVENTION

### Field of the Invention

The disclosure relates to wig manufacturing technology, in particular to a method and system for manufacturing a wig head shell.

The manufacture of wig head shells is a first step in (personalized) wig manufacture, and the molding step is the most important step of this procedure. The purpose of this step is to acquire the surface shape of the user's head to manufacture the wig fitting the user head.

At present, there exist two types of head molding methods. One that is used widely is the molding method using adhesive tape. According to that method, using a fresh-keeping film to tighten the user head, then using the adhesive tape to wind around the fresh-keeping film for fixed molding,

However, that type of molding method is complex in operation and low in molding accuracy. Moreover, during mailing when the molding is not performed on the spot, deformation due to squeeze happens, and the discarded adhesive tape and fresh-keeping film turn to be white pollution of environment. During molding, this type molding method makes the user uncomfortable, and the transmission of the obtained head model will spend a lot of time and money, which is high in cost and low in efficiency.

The second type is the mechanically contact scanning method, which is essentially a position scanning process using probe. First, using the probe to draw the outline curve at the portion of the user head where needs to be molded, then calculating the collected data with computer software to acquire three-dimensional data of the user's head.

The second method has following disadvantages: the first one, mechanical probe is used to contact the user head to collect data, the user feels uncomfortable during the data acquisition; the second one, the user is required to be in the same posture for a long time during molding with the probe, if the position of the user head changes during molding with the probe, the coordinates of the probe change accordingly, which results in inaccurate data being collected; the third one, according to this method, the probe is used to draw the outline of the user head, then three-dimensional data of the user head is calculated with computer software, the acquired data is inaccurate since the data is not collected directly. Moreover, probe scanning is not suitable for the operation on the soft scalp.

Further, there is non-contact optical scanning technique. Three dimension images are obtained by synthesizing three dimensional (3D) images and two dimensional (2D) images. According to this method, the user's head is scanned twice, in which the first time is a three dimension scanning and the second time is a two dimension scanning. Then, synthesizing the data of three dimension and the data of two dimension to obtain final three-dimensional data. This method requires twice scanning and synthesis of two dimension data and three-dimensional data, therefore, both scanning and data processing take a long time, and the finally obtained three-dimensional data tend to be inaccurate.

### SUMMARY OF THE INVENTION

In view of the above, the main purpose of the present invention is to provide a method and system for manufacturing a wig head shell, which is able to complete the manufacture of the wig head shell without contacting the body of the user, and which provides for a high degree of manufacturing accuracy and efficiency of the process.

For this purpose, the present invention provides the following technical solutions.

With the above and other objects in view there is provided, in accordance with the invention, a method for manufacturing a wig head shell which includes the following steps:

placing a plurality of markers on an object head at a location where a wig is needed;

providing a digital stereoscopic camera and acquiring a plurality of images of the object head at the location where the wig is needed from a plurality of different positions of the camera relative to the object head, each of the plurality of images containing at least three of the markers placed on the object head;

transferring digital image files of the plurality of images from the camera to a digital processing device and, in the digital processing device, combining the plurality of images to form a single three-dimensional digital model of the object head at the location where the wig is needed; and

manufacturing the head shell of the portion of the object head where the wig is needed according to the three-dimensional digital model.

In accordance with an added feature of the invention, the markers are uniform markers having a known geometry and known dimensions. In a preferred embodiment, the markers are stickers with an adhesive back and a front carrying an image of a circular spot surrounded by a circular round frame. The spot and the frame have a stark visual contrast relative to one another.

In accordance with an additional feature of the invention, prior to the step of manufacturing the head shell according to the three-dimensional digital model: modifying the three-dimensional data, performing three dimension modeling according to the modified three-dimensional data, and deleting redundant data.

In accordance with another feature of the invention, the step of modifying the three-dimensional data comprises: performing at least one of the following processes on the three-dimensional data: hole filling, sampling compression, data smoothing, noise elimination, eliminating difference between layers, adjusting a coordinate system, data editing, and surface smoothing.

In accordance with a further feature of the invention, the step of manufacturing the head shell comprises:

acquiring a head model according to the three-dimensional digital model, and manufacturing the head shell according to the head model; and

wherein the head model is a model selected from the group consisting of a plastic model, plaster model, a paraffin model, a metal model, a graphite model, and a wooden model.

In accordance with a preferred embodiment of the invention, the step of manufacturing the head shell comprises transmitting digital data representing the three-dimensional digital model to a 3D printer and building a head model with the 3D printer.

With the above and other objects in view there is also provided, in accordance with the invention, a system for manufacturing a wig head shell, comprising:

a stereoscopic camera having two lenses aligned with relatively converging optical axes;

a multiplicity of markers being stickers with a front surface carrying a visually recognizable item and an adhesive back for sticking the marker to a portion of an object head where a wig is needed;

a data processing device connected to said stereoscopic camera, said data processing device being configured to:
receive a plurality of digital image files from the stereoscopic camera;
combine the digital image files and process the image files to generate therefrom a three-dimensional digital model of the object head at a location where the wig is needed; and

a 3D printer connected to receive digital information from said data processing device and configured to build the head shell from the three-dimensional digital model of the object head.

Although the invention is illustrated and described herein as embodied in method and a system for manufacturing a wig head shell, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWING

FIG. 1 is a perspective view of a stereoscopic camera for use in the process according to the invention;

FIG. 2 is a bottom plan view showing the relative angular orientation of the optical axes of the camera;

FIG. 3 is a top view of an exemplary mannequin head with a wig placement outline marked and prepared with image marking points;

FIG. 4 is an image of the top of a head provided with marking spots ready for imaging, and the left-hand side of the picture shows a display of corresponding digital data;

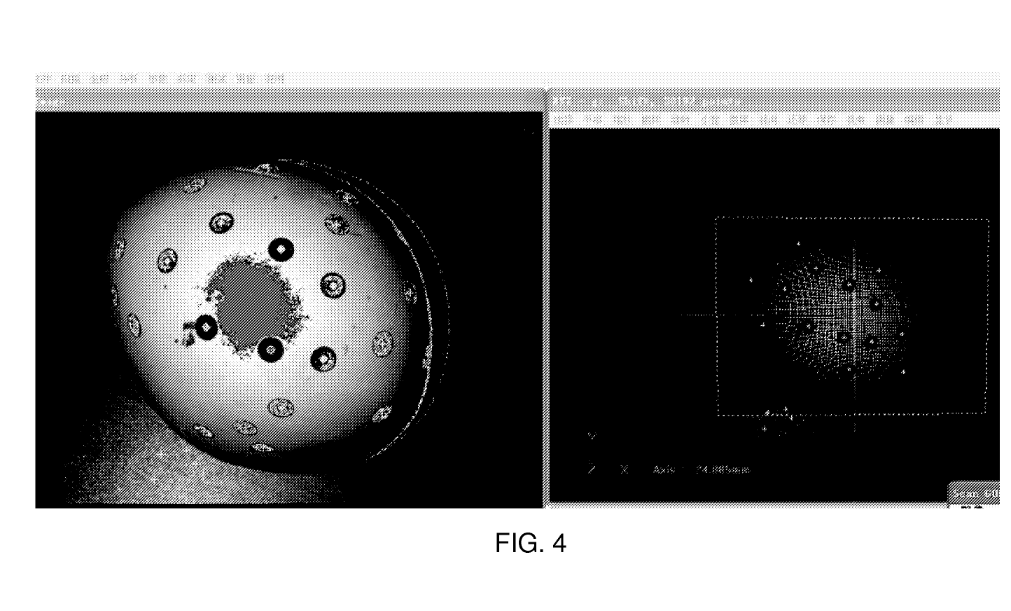

FIG. 5 is an image, similar to FIG. 4, of the top of a head provided with marking spots ready for imaging, and the left-hand side of the picture shows a display of corresponding digital data with doubled resolution relative to FIG. 4; and

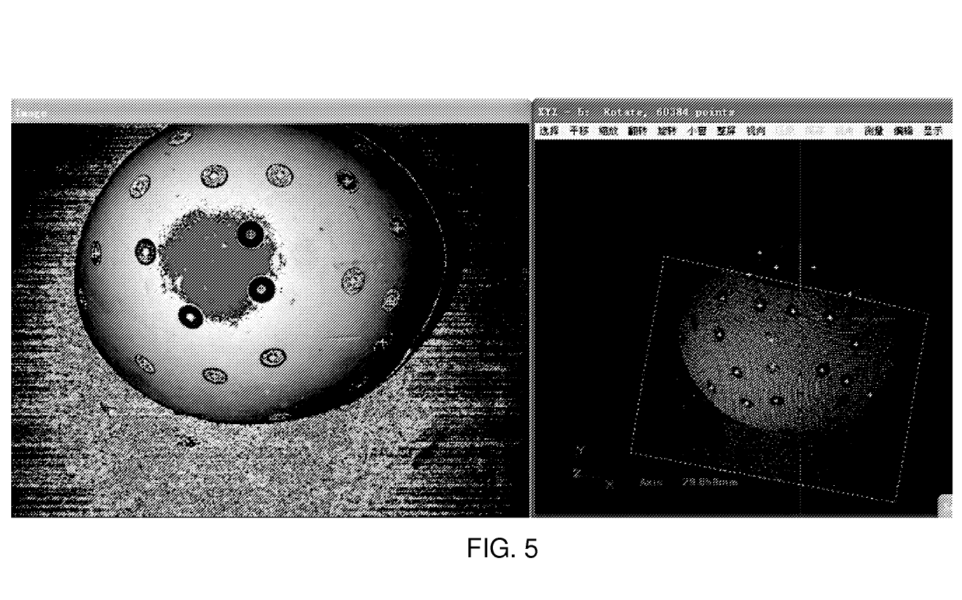

FIG. 6 is a flow diagram of the method for manufacturing wig head shell according to the present invention.

### DETAILED DESCRIPTION

According to the present invention, the system for manufacturing a wig head shell comprises a camera, a plurality of marking spots, and a programmed processor. In addition, the system may also include a 3D printer system for building a head model according to the data acquired by the camera and processed in the processor.

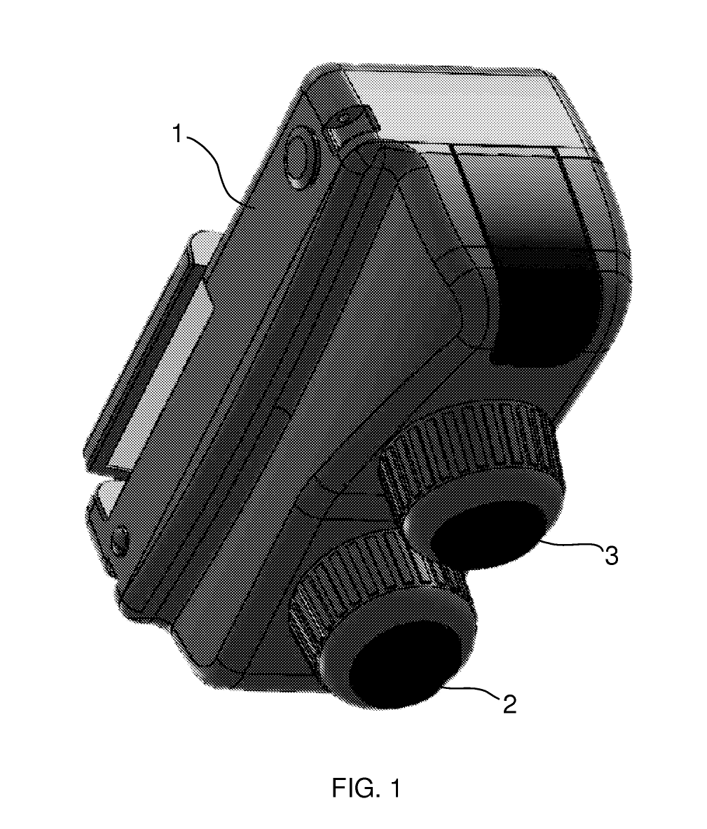

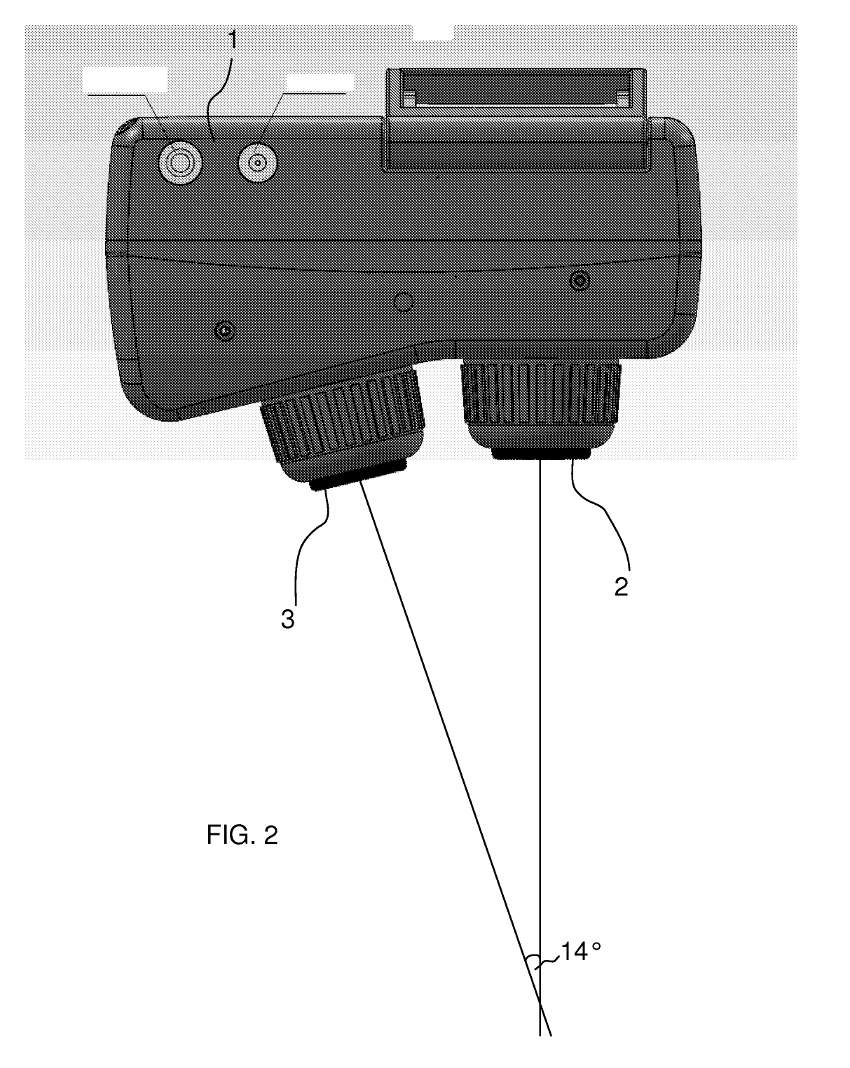

Referring now to the figures of the drawing in detail and first, particularly, to FIGS. 1 and 2 thereof, there is shown a stereoscopic (3D) camera 1. The camera has two lenses 2, 3 which are aligned with relatively converging optical axes. In the exemplary embodiment of the camera 1, the lenses are oriented at a relative angle of approximately 14°. The optical axes, therefore, converge at a distance of approximately 165 mm from the front of the lenses. While not necessary, image acquisition is best performed with an object/camera spacing distance of approximately 140 to 190 mm.

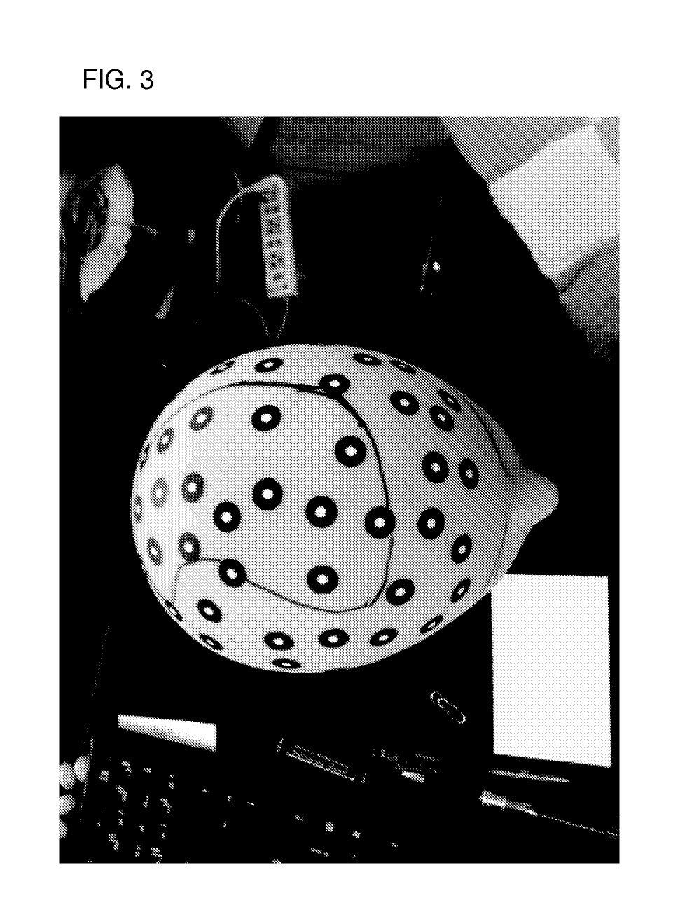

FIG. 3 shows the top of a mannequin head that is provided with markers, also referred to as points. The markers here are stickers or tags with an adhesive back and with a face that carries a white circular spot surrounded by a black ring. The spot and the outer ring do not have to be white/black, but they should exhibit a strong (stark) contrast so as to enable the digital system to easily recognize the image edges of the markers.

Prior to image acquisition, or scanning, the person's skull is prepared, as shown. A plurality of markers are placed on those surfaces where a wig is desired. In general, the markers are randomly placed. However, care should be taken not to form perfect isosceles or equilateral triangles among groups of adjacent (three) markers. Otherwise, the system may not be able to clearly and unambiguously stitch images together. Also, it is beneficial to place more markers at those surfaces with a stronger curvature and fewer markers at flatter surfaces. This increases topography accuracy and resolution of the resulting image.

It is a particular advantage of the novel system that the camera may be freely handled during data acquisition. The image processor is capable of matching the images and stitching adjacent images to one another. As can be seen, the markers are accurately measured spot markers. They are formed with high-contrast offset between the center (white) and the outside ring (black). Their dimensions are known. Accordingly, the processor system can easily determine—for each of the markers—the relative distance of the marker to the camera and the difference of the distance between adjacent markers. This provides for a gradient of the surface between the markers. The relative orientation (i.e., the angular alignment) of each marker can be determined as well. For instance, if a given marker is “measured” in an x-direction and also in a y-direction, it is possible to determine the slope of the marker, i.e., the underlying surface on which the marker is placed.

The various images acquired by the camera may manually spliced or automatically spliced. Manual splice has proved easier with complex operations but low accuracy. Auto splice results in high accuracy. Both manual and auto splice operations are possible with the hand-held camera scanner.

The data processing device is further configured to modify the three-dimensional data, perform three dimension modeling according to the modified three-dimensional data, and delete redundant data;

the data processing device is configured to perform at least one of the following processes on the three-dimensional data:

hole filling, sampling compression, data smoothing, noise elimination, eliminating difference between layers, adjusting a coordinate system, data editing, and surface smoothing.

According to the present invention, three-dimensional data of the user's head is obtained according to non-contact optical three dimension scanning method. The obtained three-dimensional data is input into the molding device for the manufacture of head shells. During the whole process, digitalization method is adopted to perform information acquisition, transmission and manufacture, thereby improving greatly efficiency and accuracy.

In one embodiment of the present invention, the above-mentioned data processing device may be a general purpose computer. Software for analyzing image and calculating position information are loaded in the general purpose computer to perform following data processes to the three-dimensional data obtained by scanning: hole filling, sampling compression, data smoothing, noise elimination, eliminating difference between layers, zooming, and adjusting the coordinate system. The data processing device performs three dimension modeling on the data, establishes and optimizes entire triangle model, and finally outputs a format that can be recognized by a general CAD/CAM software, such as asc format, obj format, wri format, sti format, or txt format. Then, the data device edits the output data through general three dimension reverse software for further optimization to delete redundant data (such as undesired positions, for example eyes), and outputs the obtained data in such a format such as IGS format or STL format.

Finally, the data processing device processes the obtained data to generate, through CAM software, a file capable of being recognized by various numerical control processing devices, in order to enable these devices to manufacture the corresponding head shell. One such system is a 3D printer that can print the head shell directly from the data provided by the computer.

Additionally, the data processing device is not limited to the general purpose computer, and may be any devices having the data processing function.

According to the present invention, molding device includes numerical control processing device and shell suction device. The numerical control processing device manufactures the head model according to the three-dimensional data obtained by the data process device. The head model may be a plastic model, a plaster model, a paraffin model, a metal model, a graphite mod, or wooden model. The shell suction device manufactures the head shell according to the head model. In the present invention, since the numerical control processing device and shell suction device are known technologies, their working principle and composition structure are omitted.

The three dimension of the present invention may be three-dimensional data, point cloud data, or three-dimensional data in any appropriate format. The present invention sets no limit to the three-dimensional data.

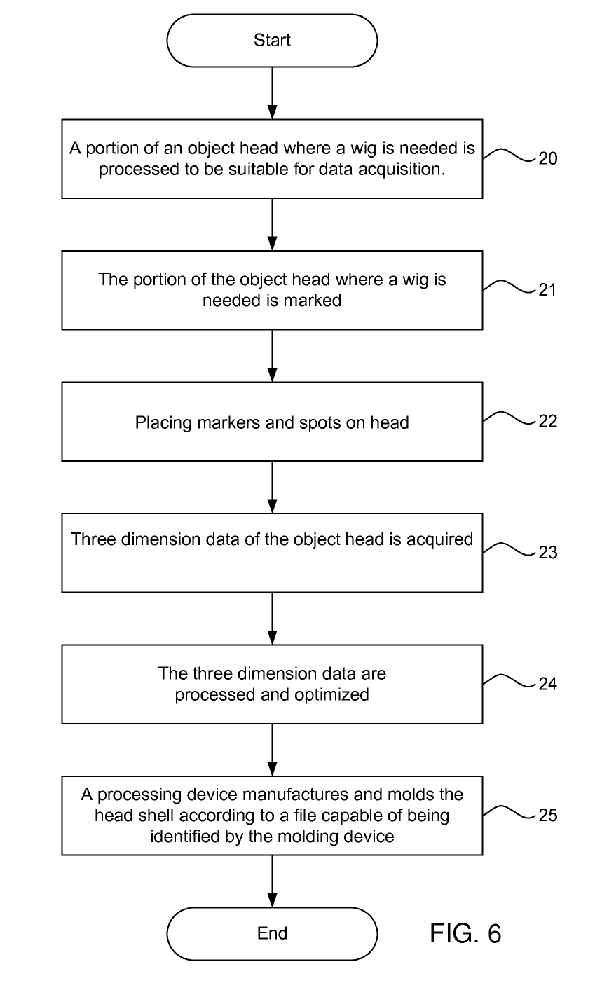

FIG. 6 shows a flow diagram of the method for manufacturing wig head shell according to the present invention. As shown in FIG. 6, the method includes the following steps.

Step 20: Processing a portion of the object head where a wig is needed to make the portion suitable for data acquisition. See, for example, FIG. 3. The processing of the head may be that covering a material suitable for shooting on the portion of the object head where a wig is needed. In the present invention, the material suitable for shooting may be cotton cloth or polysiloxane material, or the like.

Step 21: Marking the portion where a wig is needed on the object head. See, for example, the outline of a portion of the skull marked with a felt tip marker shown in FIG. 3.

Step 22: Placing markers strategically (or arbitrarily) on the portions of the head where the wig is needed. Additional markers will be placed outside the area marked in step 21, so as to allow the system to “build” a complete head.

Step 23: Acquiring three-dimensional data of the object head. The stereoscopic camera (scanner) is freely moved between images and images are acquired from a multitude of angles.

The images are stitched and processed so as to obtain curvature change information. The relative coordinate information of all pixel points are converted to three dimension information of the head shell of the portion of the object head where a wig is needed.

The data acquired by scanning are unified, or stitched, into one coordinate system to complete the scanning data combination, thereby acquiring the three-dimensional data of the head shell of the portion of the object head where a wig is needed. The specific method for determining the three-dimensional data is not described here since it has been detailed previously.

Step 24: Optimizing the three-dimensional data. In step 24, performing at least the following processes on the three-dimensional data acquired in step 23: hole filling, sampling compression, data smoothing, noise elimination, eliminating difference between layers, zooming, and adjusting the coordinate system. Then, performing three dimension modeling on the processed data, and establishing and optimizing whole triangle model.

Subsequently, the output data is edited through general three dimension reverse software for further optimization, for example, deleting redundant data (such as undesired position, for example eyes). The acquired data is output in a file format capable of being recognized by CAM software. According to the output file, a file that can be recognized by various molding device (such as cutter road file) is generated through CAM software. Since it is prior art in the art, no more details is provided here.

Step 25: The processing device manufactures and molds the head shell according to the file that can be recognized by the molding device.

The processing device of the present invention may be numerical control machine tool, shell suction device, etc.

The three-dimensional data may be three-dimensional data, cloud point data, or three-dimensional data in any appropriate format. The present invention sets no limit to the three-dimensional data.

What described above are merely preferred embodiments of the present invention, and are not intended to limit the scope of the present disclosure. Any modification, equivalent replacement and improvement within the spirit and scope of the present invention are included in the protection scope of the present invention.

1. A method of manufacturing a wig head shell, the method comprising:
placing a plurality of markers on an object head at a location where a wig is needed;
providing a digital stereoscopic camera and acquiring a plurality of images of the object head at the location where the wig is needed from a plurality of different positions of the camera relative to the object head, each of the plurality of images containing at least three of the markers placed on the object head;
transferring digital image files of the plurality of images from the camera to a digital processing device and, in the digital processing device, combining the plurality of images to form a single three-dimensional digital model of the object head at the location where the wig is needed; and
manufacturing the head shell of the portion of the object head where the wig is needed according to the three-dimensional digital model.

2. The method according to claim 1, wherein the markers are uniform markers having a known geometry and known dimensions.

3. The method according to claim 2, wherein the markers are stickers with an adhesive back and a front carrying an image of a circular spot surrounded by a circular round frame, the spot and the frame have a stark visual contrast relative to one another.

4. The method according to claim 1, further comprising, prior to the step of manufacturing the head shell according to the three-dimensional digital model:
modifying the three-dimensional data, performing three dimension modeling according to the modified three-dimensional data, and deleting redundant data.

5. The method according to claim 4, wherein the step of modifying the three-dimensional data comprises:
performing at least one of the following processes on the three-dimensional data: hole filling, sampling compression, data smoothing, noise elimination, eliminating difference between layers, adjusting a coordinate system, data editing, and surface smoothing.

6. The method according to claim 1, wherein the step of manufacturing the head shell comprises:
acquiring a head model according to the three-dimensional digital model, and manufacturing the head shell according to the head model; and
wherein the head model is a model selected from the group consisting of a plastic model, plaster model, a paraffin model, a metal model, a graphite model, and a wooden model.

7. The method according to claim 1, wherein the step of manufacturing the head shell comprises transmitting digital data representing the three-dimensional digital model to a 3D printer and building a head model with the 3D printer.

8. A system for manufacturing a wig head shell, comprising:
a stereoscopic camera having two lenses aligned with relatively converging optical axes;
a multiplicity of markers being stickers with a front surface carrying a visually recognizable item and an adhesive back for sticking the marker to a portion of an object head where a wig is needed;
a data processing device connected to said stereoscopic camera, said data processing device being configured to:
receive a plurality of digital image files from the stereoscopic camera;
combine the digital image files and process the image files to generate therefrom a three-dimensional digital model of the object head at a location where the wig is needed; and
a 3D printer connected to receive digital information from said data processing device and configured to build the head shell from the three-dimensional digital model of the object head.

9. The system according to claim 8, wherein:
said data processing device is further configured to modify the three-dimensional data, perform three dimension modeling according to modified three-dimensional data, and delete redundant data; and
said data processing device is configured to perform at least one of the following processes on the three-dimensional data:
hole filling, sampling compression, data smoothing, noise elimination, eliminating difference between layers, adjusting a coordinate system, data editing, and surface smoothing.
